(19) United States
(12) Patent Application Publication
(10) Pub. No.: US 2014/0169035 A1
(43) Pub. Date: Jun. 19, 2014

(54) LIGHT GUIDE PLATE AND BACKLIGHT MODULE INCORPORATING THE SAME

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 14/049,218

(22) Filed: Oct. 9, 2013

(30) Foreign Application Priority Data
Dec. 13, 2012 (TW) 101147267

(51) Int. Cl. F21V 8/00

(52) U.S. Cl. CPC G02B 6/002
USPC 362/612; 362/621

(57) ABSTRACT

A light guide plate includes a light incident face, a light exit face adjacent to the light incident face, a bottom face adjacent to the light incident face and opposite to the light exit face, and a plurality of sidewalls beside the light incident face and interconnecting the bottom face and the light exit face. The light incident face is recessed inwardly from an outer periphery of the light guide plate toward an interior of the light guide plate to define a recessed region of the light guide plate. The light incident face is perpendicular to the light exit face. A backlight module incorporating the light guide plate is also provided. The backlight module includes at least a light emitting diode located in the recessed region of the light guide plate.

### TECHNICAL FIELD

The present disclosure relates generally to a light guide plate and a backlight module incorporating the light guide plate.

### DESCRIPTION OF RELATED ART

LEDs are solid state light emitting devices formed of semiconductors, which are more stable and reliable than other conventional light sources such as incandescent bulbs. Thus, LEDs are being widely used in various fields such as numeral/character displaying elements, signal lights, light sources for lighting and display devices.

Nowadays, LED light sources are widely applied in an edge type backlight module. The LED light sources are usually positioned at one side of a light guide plate. The light guide plate includes a light incident face facing the LED light sources, a bottom face adjacent to the light incident face, and a light exit face adjacent to the light incident face and opposite to the bottom face thereof. However, as the light incident face is a flat surface, light rays emitted from the LED light sources are refracted at a small angle of refraction into the light guide plate through the light incident face, thereby leaving two dark, strip-shaped areas inside the light guide plate along two side edges thereof which are not sufficiently illuminated. Therefore, such a light guide plate and a backlight module incorporating the light guide plate are difficult to satisfy the requirements of uniform light distribution.

What is needed therefore is a light guide plate and a backlight module incorporating the light guide plate which can overcome the above mentioned limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a perspective, exploded view of a backlight module in accordance with a first embodiment of the present disclosure.

FIG. 2 is a top plan, assembled view of the backlight module of FIG. 1.

FIG. 3 is a perspective, exploded view of a backlight module in accordance with a second embodiment of the present disclosure.

FIG. 4 is a perspective view of a backlight module in accordance with a third embodiment of the present disclosure.

FIG. 5 is a perspective view of a backlight module in accordance with a fourth embodiment of the present disclosure.

### DETAILED DESCRIPTION

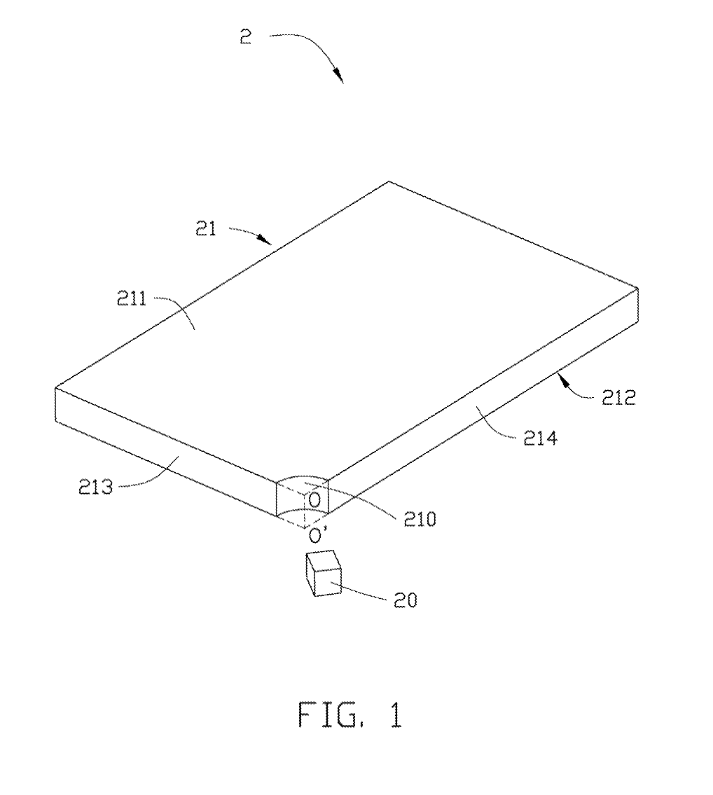

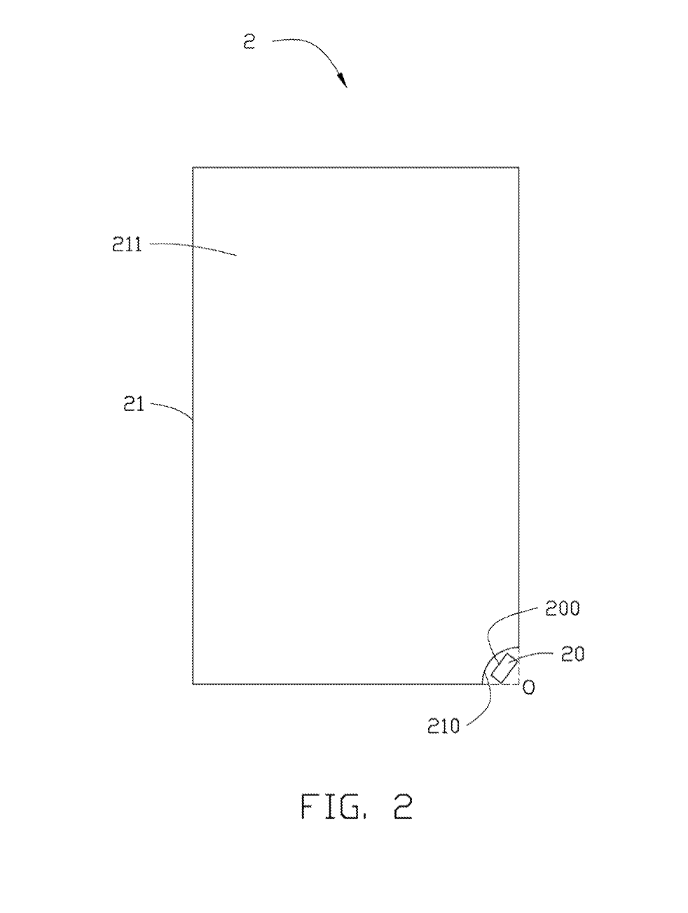

Referring to FIGS. 1 and 2, a backlight module 2 in accordance with a first embodiment of the present disclosure includes a light guide plate 21 and a light emitting diode (LED) light source 20 coupled to the light guide plate 21. The light guide plate 21 includes a light incident face 210, a light exit face 211 adjacent to the light incident face 210, a bottom face 212 adjacent to the light incident face 210 and opposite to the light exit face 211, and a plurality of sidewalls (i.e., a first sidewall 213 and a second sidewall 214) perpendicular to each other, extending from two opposite edges of the light incident face 210 and located between the light exit face 211 and the bottom face 212.

The light guide plate 21 is cuboid-shaped. The light incident face 210 is formed at a corner of the light guide plate 21. The light incident face 210 is recessed inwardly in a diagonal direction from the corner of the light guide plate 21 toward an opposite corner of the light guide plate 21. The light incident face 210 is perpendicular to the light exit face 211.

An extension of the first sidewall 213 of the light guide plate 21 intersects with an extension of the adjacent second sidewall 214 at a first straight line OO′. The first straight line OO′ is a corner edge of the corner of the light guide plate 21 which is recessed to form the light incident face 210. The light incident face 210 is arc shaped and located around the first straight line OO′. The LED light source 20 is located between the light incident face 210 and the first straight line OO′ when in use, with a light emitting face 200 thereof facing the light incident face 210 of the light guide plate 21.

In the present embodiment, the light incident face 210 is a concave face, and light emitted from the LED light source 20 is refracted at a large angle of refraction into the light guide plate 21 through the light incident face 210, thereby eliminating the dark strip-shaped area inside the light guide plate 21. Thus, the backlight module 2 having a uniform light distribution inside the light guide plate 21 is obtained.

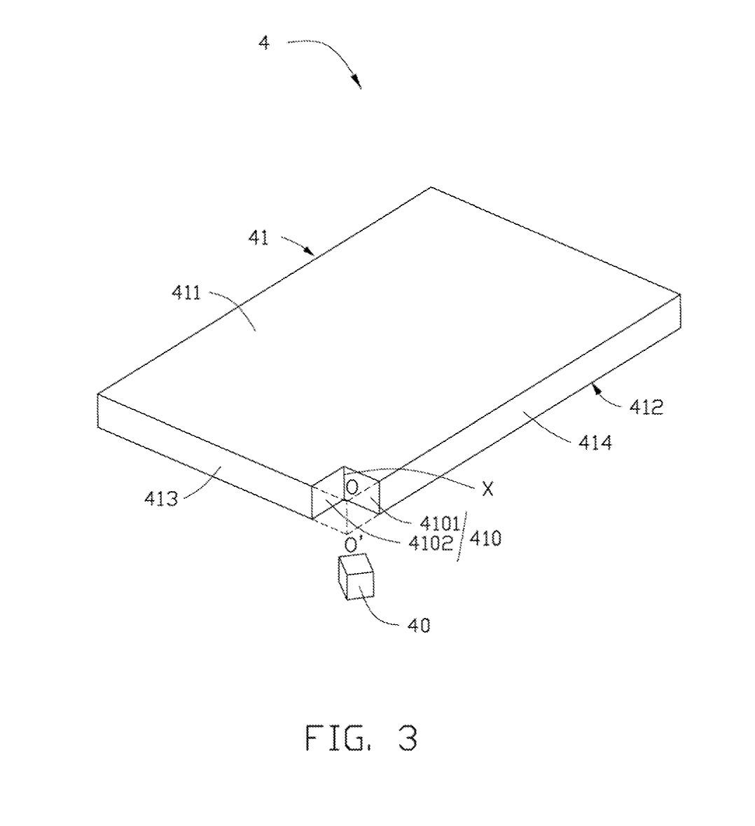

Referring to FIG. 3, different from the backlight module 2 shown in FIG. 2, a light incident face 410 of a light guide plate 41 of a backlight module 4 in accordance with a second embodiment of the present disclosure is V-shaped. The light incident face 410 includes a first light incident face 4101 and a second light incident face 4102.

The first light incident face 4101 is parallel to the first sidewall 413 of the light guide plate 41. The second light incident face 4102 is parallel to the second sidewall 414 of the light guide plate 41. The first light incident face 4101 intersects with the second light incident face 4102 at a second straight line X. The second straight line X lies inside of and opposite and parallel to the first straight line OO′. In use, the LED light source 40 is located between the first straight line OO′ and the second straight line X of the light incident face 410.

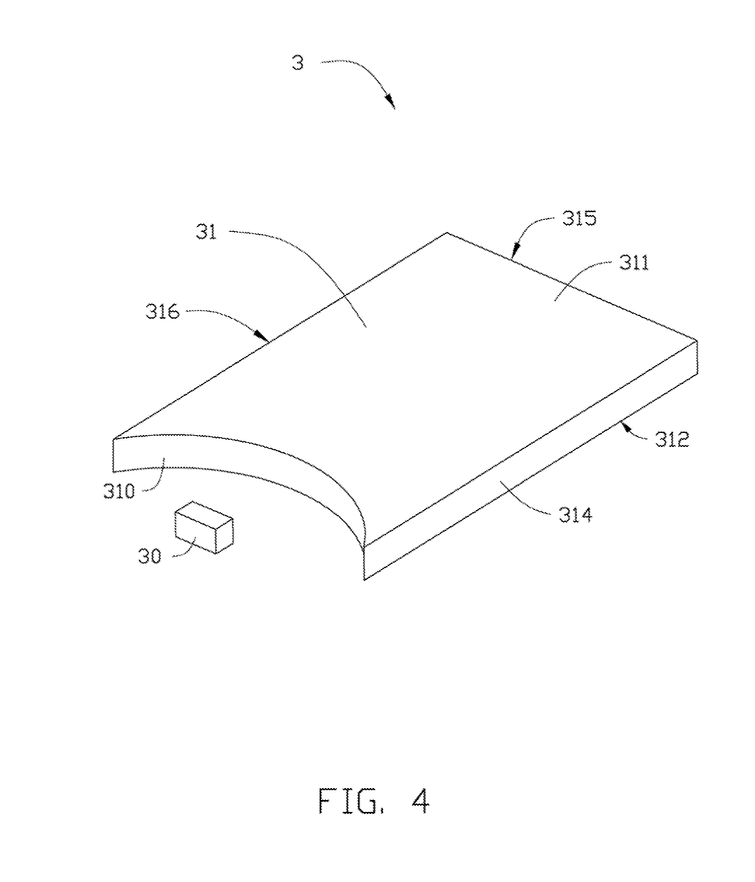

Referring to FIG. 4, different from the backlight module 2 shown in FIG. 2, a light incident face 310 of a light guide plate 31 of a backlight module 3 is recessed inwardly in a length direction of the light guide plate 31 toward a third sidewall 315 of the light guide plate 31 to define a recessed region. The light incident face 310 is arc-shaped and interconnects a fourth sidewall 316 and a second sidewall 314 of the light guide plate 31. A distance between the light incident face 310 and the third sidewall 315 firstly decreases gradually and then increases gradually along a direction from the fourth sidewall 316 toward the second sidewall 314 of the light guide plate 31. An LED light source 30 is received in the recessed region and faces a center of the light incident face 310 of the light guide plate 31.

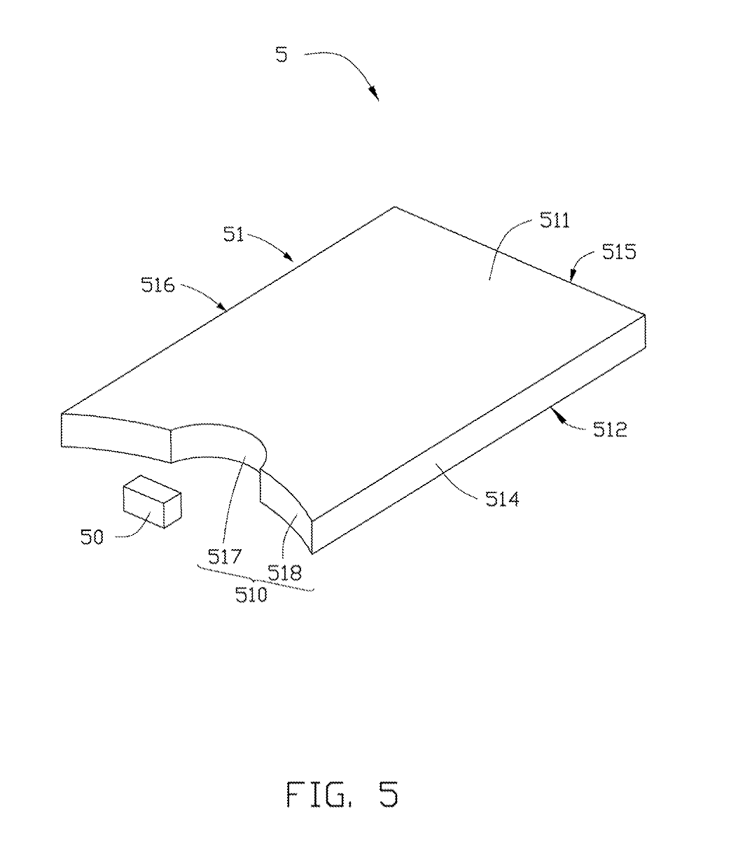

Referring to FIG. 5, different from the backlight module 3 shown in FIG. 4, a light incident face 510 of a light guide plate 51 of a backlight module 5 includes a third light incident face 518 and a fourth light incident face 517. The light incident face 510 of the light guide plate 51 is recessed inwardly in a length direction of the light guide plate 51 toward a third sidewall 515 of the light guide plate 31 to define a recessed region. The fourth light incident face 517 is recessed inwardly from a central portion of the third light incident face 518 toward the third sidewall 515 of the light guide plate 51 along the length direction of the light guide plate 51. The light incident face 510 interconnects a fourth sidewall 516 and a second sidewall 514 of the light guide plate 51. The third light incident face 518 and the fourth light incident face 517 are both arc-shaped and have different radiuses. In the present embodiment, the fourth light incident face 517 has a radius smaller than that of the third light incident face 518. An LED light source 50 is received in the recessed region and faces the light incident face 510 of the light guide plate 51. More particularly, the LED light source 50 faces the fourth light incident face 517 of the light incident face 510.

As a light intensity distribution of the LED light source 50 is mostly concentrated at an optical axis while becomes gradually weaker towards a periphery thereof, a part of light rays concentrated near the optical axis is refracted at a large angle of refraction into the light guide plate 51 through the fourth light incident face 517 of the light incident face 510, and another part of the light rays at the periphery of the distribution is refracted at a small angle of refraction into the light guide plate 51 through the third light incident face 518 of the light incident face 510. Thus, the backlight module 5 having a uniform light distribution inside the light guide plate 51 is obtained.

In the present embodiment, light rays existing within a forward angle less than 60 degrees are refracted into the light guide plate 51 through the fourth light incident face 517, and light rays existing within a forward angle more than 60 degrees are refracted into the light guide plate 51 through the third light incident face 518.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A light guide plate comprising:
a light incident face, a light exit face adjacent to the light incident face, a bottom face adjacent to the light incident face and opposite to the light exit face, and a plurality of sidewalls beside the light incident face and interconnecting the light exit face and the bottom face;
wherein the light incident face is recessed inwardly from an outer periphery of the light guide plate toward an interior of the light guide plate to define a recessed region, and the light incident face is perpendicular to the light exit face, the recessed region being configured for receiving at least a light emitting diode (LED) light source therein.

2. The light guide plate of claim 1, wherein the light guide plate is cuboid-shaped, and the light incident face is formed at a corner of the light guide plate.

3. The light guide plate of claim 2, wherein the light incident face is recessed inwardly in a diagonal direction from the corner of the light guide plate towards an opposite corner of the light guide plate.

4. The light guide plate of claim 3, wherein an extension of a first sidewall of the light incident face adjacent to the light incident face intersects with an extension of a second sidewall of the light incident face adjacent to the light incident face at a first straight line which is a corner edge of the corner recessed for forming the light incident face.

5. The light guide plate of claim 4, wherein the light incident face is arc shaped and located around the first straight line.

6. The light guide plate of claim 4, wherein the light incident face is V-shaped, the light incident face comprises a first light incident face parallel to the first sidewall of the light guide plate adjacent to the light incident face and a second light incident face parallel to the second sidewall of the light guide plate adjacent to the light incident face.

7. The light guide plate of claim 6, wherein the first light incident face intersects with the second light incident face at a second straight line, and the second straight line is located inside of and opposite and parallel to the first straight line.

8. The light guide plate of claim 1, wherein the light guide plate is cuboid-shaped, and the light incident face is recessed inwardly in a length direction of the light guide plate from a first sidewall towards a third sidewall of the light guide plate opposite to the first sidewall.

9. The light guide plate of claim 8, wherein the light incident face is arc shaped.

10. The light guide plate of claim 9, wherein the light incident face comprises a third light incident face and a fourth light incident face, and the fourth light incident face is recessed inwardly from a central portion of the third light incident face towards an interior of the light guide plate along a length direction of the light guide plate.

11. The light guide plate of claim 10, wherein the fourth light incident face has a radius smaller than that of the third light incident face.

12. A backlight module comprising:
a light emitting diode element; and
a light guide plate optically coupled to the light emitting diode element, comprising:
a light incident face, a light exit face adjacent to the light incident face, a bottom face adjacent to the light incident face and opposite to the light exit face, and a plurality of sidewalls beside the light incident face and interconnecting the light exit face and the bottom face;
wherein the light incident face is recessed inwardly from an outer periphery of the light guide plate toward the interior of the light guide plate, and the light incident face is perpendicular to the light exit face; and
wherein the light emitting diode element faces the light incident face of the light guide plate.

13. The backlight module of claim 12, wherein the light guide plate is cuboid-shaped, the light incident face is recessed from a corner of the light guide plate.

14. The backlight module of claim 13, wherein the light incident face is recessed inwardly in a diagonal direction from the corner of the light guide plate towards an opposite corner of the light guide plate.

15. The backlight module of claim 14, wherein an extension of a first sidewall of the light guide plate adjacent to the light incident face intersects with an extension of a second sidewall of the light guide plate adjacent to the light incident face at a first straight line, and the light emitting diode element is located between the light incident face and the first straight line.

16. The backlight module of claim 15, wherein the light incident face is V-shaped, the light incident face comprises a first light incident face parallel to the first sidewall of the light guide plate adjacent to the light incident face and a second light incident face parallel to the second sidewall of the light guide plate adjacent to the light incident face, and the first light incident face intersects with the second light incident face at a second straight line lying inside of and parallel and opposite to the first straight line, the light emitting diode element being located between the first and second straight lines.

17. The backlight module of claim 12, wherein the light guide plate is cuboid-shaped, and the light incident face is recessed inwardly in a lengthways direction of the light guide plate from a first sidewall towards a third sidewall of the light guide plate opposite to the first sidewall.

18. The backlight module of claim 17, wherein the light incident face is arc shaped.

19. The backlight module of claim 18, wherein the light incident face comprises a third light incident face and a fourth light incident face, and the fourth light incident face is recessed inwardly from a central portion of the third light incident face toward the interior of the light guide plate along the lengthways direction of the light guide plate.

20. The backlight module of claim 19, wherein the fourth light incident face has a radius smaller than that of the third light incident face.
